(19) United States
(12) Patent Application Publication
(10) Pub. No.: US 2008/0244053 A1
(43) Pub. Date: Oct. 2, 2008

(54) GEOGRAPHIC READER DISPLAY DATA

(75) Inventors: Todd Sampson, Orlando, FL (US); John Sampson, Orlando, FL (US); Steve Ho, Apopka, FL (US); Eric Marcoullier, San Francisco, CA (US); Neil Scott Rafer, San Francisco, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/694,752

(22) Filed: Mar. 30, 2007

(51) Int. Cl. G06F 15/173

(52) U.S. Cl. 709/223

(57) ABSTRACT

A client device, system, and method are directed towards determining data on network site visits, and providing the data based on a geographical relationship of visitors to the network sites. A tracker tracks visits to, and outbound link click activity on a network site. If the click is associated with a URI, information is collected related to the click, including a network address associated with a source of the click. A geographic region may be determined based on the network address of the click source. Statistics may then be collected over time, including, what network sites, are visited for a given geographic region. Such statistics may be displayable in a variety of formats, and geographic regions, including by country, state, province, city, town, district, county, or the like. The tracker may be on the network site or on a client device of the visitor.

### TECHNICAL FIELD

The present invention relates generally to network analytics tools and, more particularly, but not exclusively to determining statistical data on network site visits, page views, and outbound clicks, and to providing the statistical data based on a geographical relationship of visitors to network sites.

### BACKGROUND

Tremendous changes have been occurring in the Internet that influence our everyday lives. For example, online social networks have become the new meeting grounds. They have been called the new power lunch tables and new golf courses for business life in the U.S. Moreover, many people are using such online social networks to reconnect themselves to their friends, their neighborhood, their community, and the world.

The development of such online social networks touch countless aspects of our everyday lives, providing instant access to people of similar mindsets, and enabling us to form partnerships with more people in more ways than ever before. For example, an increasing number of people are creating and/or visiting network blogs (or web logs). Briefly, a blog is a website where a user may provide commentaries, news, graphics, videos, or the like, in a journal style. Such entries may be on virtually any subject, including food, politics, movies, movie stars, videos, music, gambling, shopping, politics, or even personal online diaries.

With bloggers (blog authors) talking amongst each other on their blog sites, many may wonder who is actually reading the blogs. While, readers may be able to provide some insight to this question by leaving comments on a blog site, little may be known about the overall readership. However, many people, including the bloggers may want to understand their readership better. Knowing ones readership enables the blogger to better adjust their material, and potentially even select sponsorship for their blog. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be included in a system implementing the invention;

FIG. 3 shows one embodiment of a network device that may be included in a system implementing the invention;

FIG. 4 illustrates a logical flow diagram generally showing one embodiment of a process for determining readership statistics of various websites, and enabling display of website readership based, in part, on a geographic region;

FIG. 5 illustrates one embodiment of an example display of readership (visitor) statistics based on a geographic region; and

FIG. 6 illustrates another embodiment of an example display of readership statistics based on another geographic region, in accordance with the present invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated the present invention is directed towards determining data on network site visits, and providing the data based on a geographical relationship of visitors to network sites. In one embodiment, a tracker is provided that tracks visits to, and outbound link click activity. When a click is detected within a webpage a determination is made whether the click is associated with a link, such as a Universal Resource Locator (URL) link, Uniform Resource Identifier (URI) link, or the like. As used herein, the term URI includes URLs, Uniform Resource Names (URNs), and virtually any other addressing technology for identifying a resource on a network. If the click is associated with a URI, information is collected related to the click, including the URI, a link text, a network address associated with a source of the click, a timestamp of when the click is detected, and the like. The collected information may then be analyzed. In one embodiment, a geographic region is determined based on the network address of the click source. Statistics may then be collected over time, including, what URIs, or websites, are visited for a given geographic region. Such statistics may be displayable in a variety of formats, and geographic regions, including by country, by state or provinces, cities, towns, districts, counties, or the like. Moreover, the statistics may be displayed in a table format, list format, map format, or the like.

In one embodiment, the tracker may be a JavaScript that may be employed by a webpage, or domain site, seeking to track visitor activity. However, in another embodiment, the tracker may also operate as a script, application, applet, or the like. In one embodiment, the tracker may reside within a visitor's client device. In one embodiment, the tracker may be implemented within a tool bar of a browser on a client device, for example.

### Illustrative Operating Environment

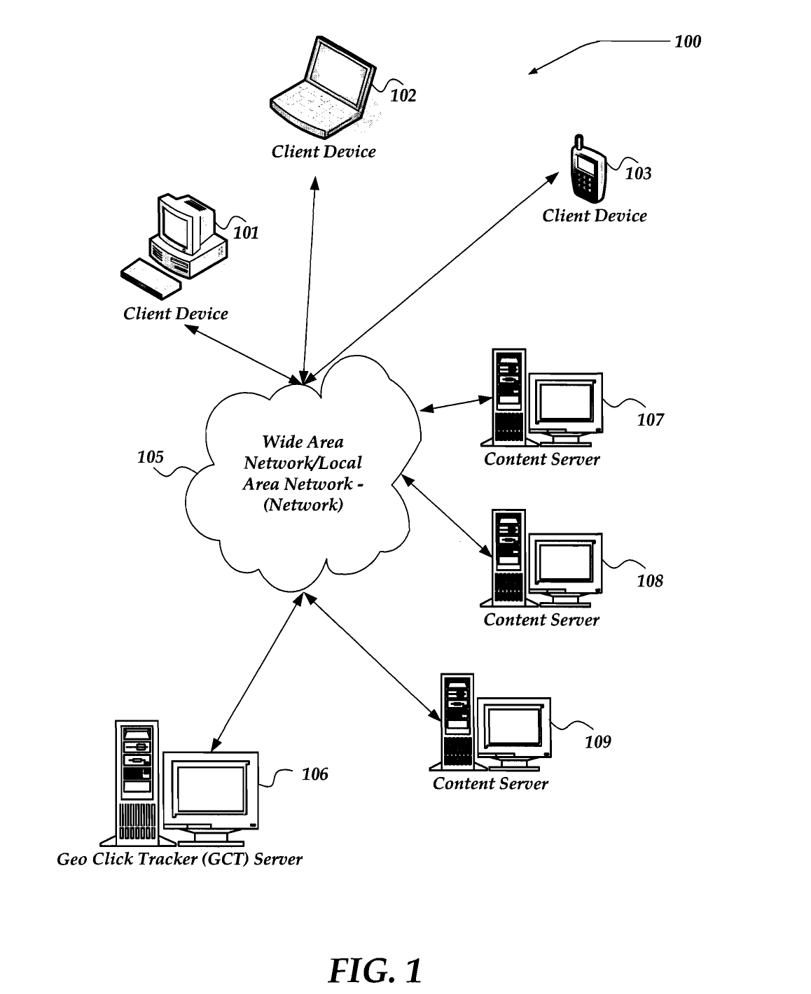

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, Geo Click Tracker (GCT) Server 106, client devices 101-103, and content servers 107-109.

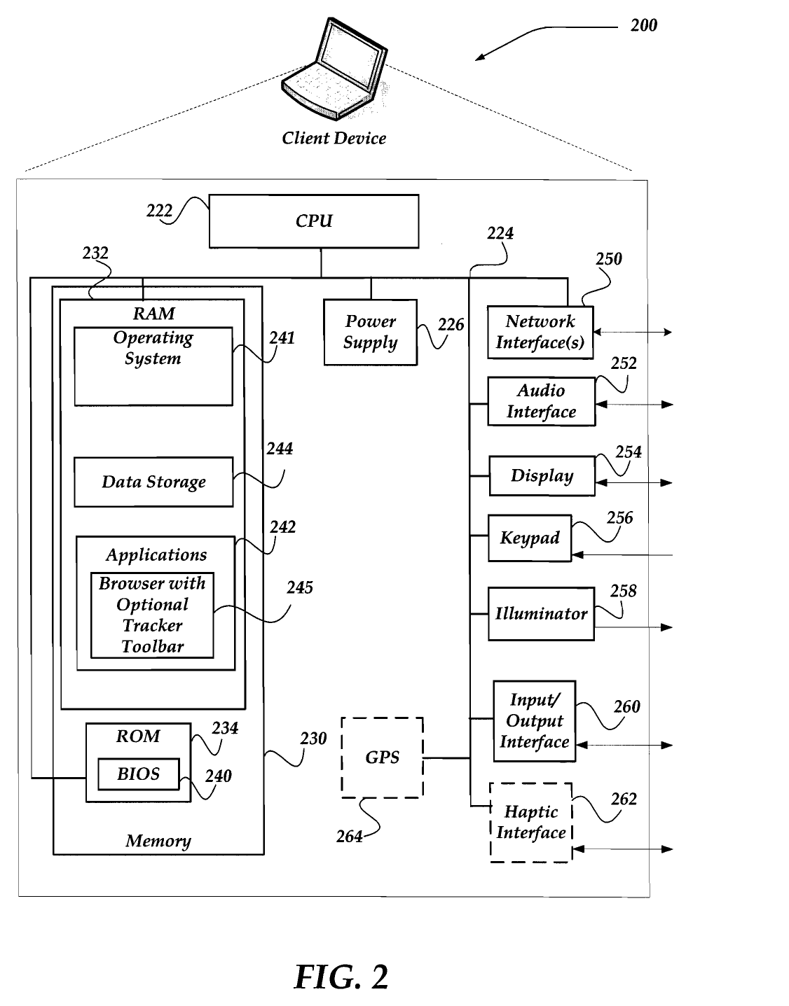

One embodiment of client devices 101-103 is described in more detail below in conjunction with FIG. 2. Generally, client devices 101-103 may include virtually any computing device capable of connecting to another computing device to send and receive information, including web requests for information from a server, providing content, or the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, radio frequency (RF) devices, infrared (IR) devices, integrated devices combining one or more of the preceding devices, or virtually any network device. Similarly, client devices 101-103 may be any device that is capable of connecting using a wired or wireless communication medium such as a PDA, POCKET PC, wearable computer, and any other device that is equipped to communicate over a wired and/or wireless communication medium.

Client devices 101-103 may reside in any of a variety of geographic regions within the world. For example, client device 101 may reside in a particular region within San Francisco, Calif.; client device 102 may reside in Singapore; while client device 103 may reside in Paris, France. However, the client devices are not constrained to these locations, and it should be clear that not only may client devices 101-103 reside in regions other than the examples, but, that at least one of client devices 101-103 may be configured to relocate its geographic region. Moreover, although only three client devices are illustrated, it should be clear that client devices 101-103 are merely representative of a plurality of client devices that may be located in a plurality of same, and/or different regions throughout the world.

Client devices 101-103 may also include a client application that may be configured to provide information that identifies itself, including a type, capability, name, and the like. Client devices 101-103 may identify themselves through any of a variety of mechanisms, including a phone number, Mobile Identification Number (MIN), an electronic serial number (ESN), or a network address, such as an Internet Protocol (IP) address, or other network address identifier. In one embodiment, client devices 101-103 may be configured to provide such network address identifier in a message, or the like, sent over network 105 to another computing device.

Client devices 101-103 may further include a client application that is configured to manage various actions. For example, client devices 101-103 may include a web browser application that is configured to enable an end-user to interact with other devices and/or applications over network 105. For example, client devices 101-103 may enable use of the web browser to access content, web pages, or the like, from another computing device, such as content servers 107-109, or the like. In one embodiment, client devices 101-103 may receive a script, applet, application, or the like, that may be configured to operate in conjunction with the web browser application. For example, in one embodiment, client devices 101-103 may be configured to download and/or install a plug-in application, script, applet, or the like, into the web browser. In one embodiment the plug-in may operate as a toolbar component, or the like, to the web browser. In any event, in one embodiment, the application, script, applet, or the like, may be configured to track network activity of the client device. For example, when a user of the client device clicks on a location within a webpage displayed within the web browser, the application, script, applet, or the like, may record information about the click activity. The recorded information may be stored locally on client device 101-103, and/or sent over network 105 to GCT server 106. In one embodiment, additional information may be provided, including a network address associated with the client device, a timestamp, or the like.

In addition, client devices 101-103 may employ a variety of other client applications to communicate with other devices over network 105, including, but not limited to Voice Over Internet Protocol (VOIP), Instant Messaging (IM), Short Message Service (SMS), Multimedia Message Service (MMS), email, or the like. Thus, client devices 101-103 may employ a variety of mechanisms to establish network sessions with another computing device.

Network 105 is configured to couple one computing device with another computing device to enable them to communication information. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between one computing device and another computing device.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Content servers 107-109, in one embodiment, are configured to operate as website servers. However, content servers 107-109 are not limited to web servers, and may also operate a messaging server, a File Transfer Protocol (FTP) server, a database server, content server, and the like. Additionally, each of s content servers 107-109 may be configured to perform a different operation. Thus, for example, content server 107 may be configured as a blog website, while content server 108 may be configured as music or video download server. Moreover, while content servers 107-109 may operate as other than a website, they may still be enabled to receive an HTTP communication. In one embodiment, content servers 107-109 may each operate a blog site.

In one embodiment, content servers 107-109 may include a click tracker that is configured to monitor visitor activity. In one embodiment, the click tracker may be configured as a JavaScript. However, the invention is not so limited, and in other embodiments, the click tracker may be configured as a downloaded plug-in for a client web browser, or the like. In another embodiment, click tracker may be configured as an application, applet, or the like. In any event, click tracker may monitor for click activity by a visitor. When a click is detected, click tracker may record information related to the click, including, but not limited to, a network address of the visitor, a link that is clicked on, text associated with the link, a time the click is detected, or the like. Click tracker may store the recorded information, and/or provide the recorded information to GCT 106.

Devices that may operate as content servers 107-109 include personal computers desktop computers, multiprocessor systems, microprocessor-based or programmable consumer electronics, network PCs, servers, and the like.

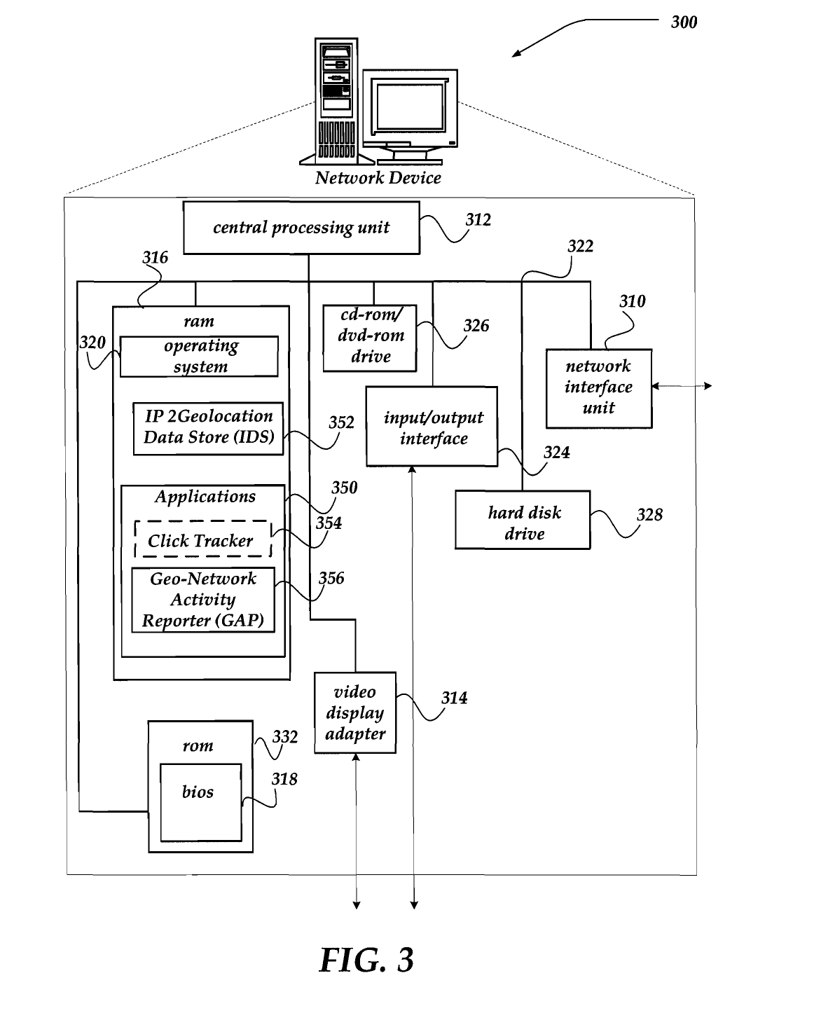

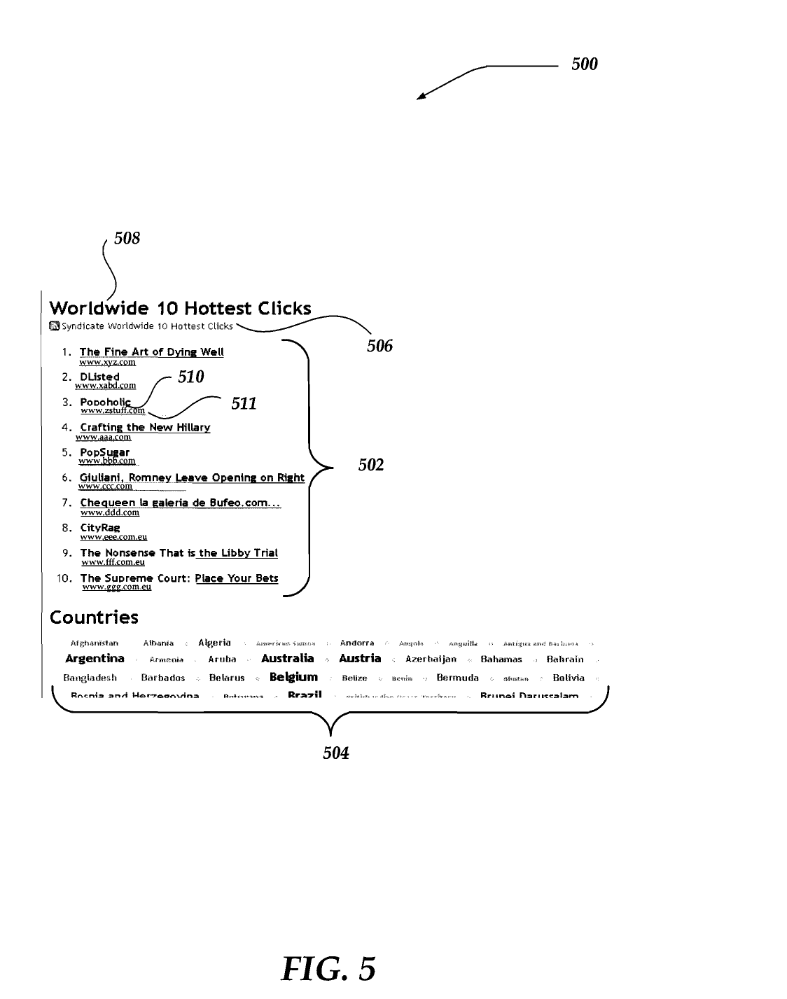

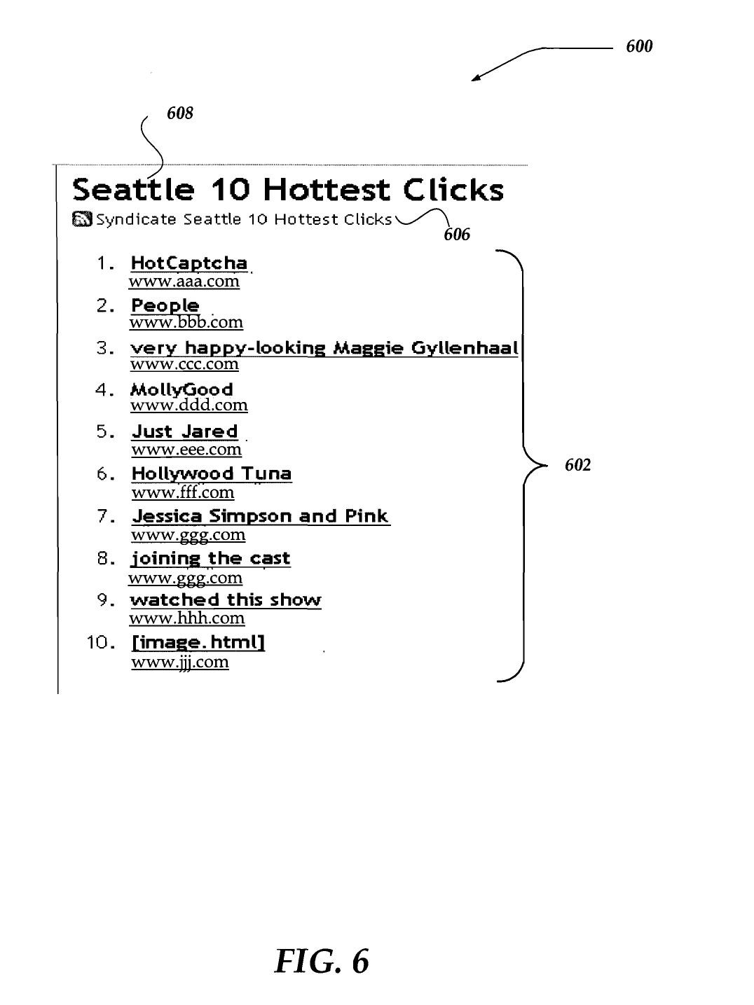

One embodiment of GCT 106 is described in more detail below in conjunction with FIG. 3. Briefly, however, GCT 106 may include any computing device capable of connecting to network 105 to enable aggregation, analysis, and/or display of network statistics based, in part, on geographic regions. In one embodiment, the display of network statistics represent network sites visited based on a geographic region of the visitor. For example, in one embodiment, network sites most visited by client devices residing within a particular geographic region may be displayed. In one embodiment, the geographic region data may be refined from a country to a state, to a city, or so forth. Two examples illustrations of such geographic network site data are described below in conjunction with FIGS. 5-6.

GCT 106 may be configured to receive network data from a variety of sources, including, for example, content servers 107-109, and/or client devices 101-103. In one embodiment, the network data may include information about a click activity at a network site. Such information may include a URI clicked on, a network address associated with the client device initiating the click activity, a timestamp for when the click is detected, or the like. In one embodiment, the information may also include geographic information associated with the client device initiating the click activity. However, in another embodiment, GCT 106 may be configured to employ a translator of a network address to a physical geographic location.

Devices that may operate as GCT 106 include personal computers desktop computers, multiprocessor systems, microprocessor-based or programmable consumer electronics, network PCs, servers, and the like.

Although FIG. 1 illustrates GCT 106 as a single computing device, the invention is not so limited. For example, one or more functions of GCT 106 may be distributed across one or more distinct computing devices. For example, aggregating of click tracker data, determining a geographic region associated with the click tracker data, preparing and/or displaying of the resulting network statistics for a given geographic region, or the like, may be performed by a plurality of computing devices, without departing from the scope or spirit of the present invention. Moreover, in one embodiment, GCT 106 may also be configured to operate as a content server. Thus, in one embodiment, GCT 106 may also collect click network data.

### Illustrative Mobile Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, client devices 101-103 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, an optional haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Optional haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 and/or other data. For example, data storage 244 may also be employed to store information that describes various capabilities of client device 200. The information may then be provided to another device based on any of a variety of events, including being sent as part of a header during a communication, sent upon request, or the like. Moreover, data storage 244 may also be employed to store social networking information including vitality information, or the like. At least a portion of the social networking information may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may further include a browser application, such as browser 245. In one embodiment, browser 245 may include an optional tracker plug-in. In one embodiment, the tracker plug-in may operate within a toolbar of browser 245. In one embodiment, the plug-in may be implemented as a script, an applet, a program, an Application Programming Interface (API) to an application, script, applet, or the like.

Browser 245 may be configured to receive and to send web pages, web-based messages, or the like. Browser 245 may also be configured to receive and display graphics, text, multimedia, and the like, employing virtually any web based language, including, but not limited to a wireless application protocol messages (WAP), or the like. In one embodiment, browser 245 is enabled to employ HyperText Markup Language (HTML), Handheld Device Markup Language (HDML), Wireless Markup Language (WML), WMLScript, JavaScript, Standard Generalized Markup Language (SMGL), extensible Markup Language (XML), and the like, to display and/or send network information. In one embodiment, browser 245 may be configured to receive and send information using a network cookie, or the like. Moreover, browser 245 may be configured to send and/or receive at least some information over an encrypted network channel, using, for example, Secure Socket Layers (SSL), Transport Layer Security (TLS), Wireless Transport Layer Security (WTLS), Wireless Transport Layer Security (EAP), or the like.

In one embodiment, where browser 245 includes an optional tracker, browser 245 may then be configured to further track a user's network activities including within and/or outbound click activities. Briefly, a click activity includes virtually any machine readable action by a user through computer interfaces, such as a mouse, stylus, keyboard, or the like, wherein an input is received over a network. Such click activity may include for example, a signal sent over the network indicating a depression of a button on a computer mouse. However, click activity may also include a signal sent over the network that may originate from an audio input, as well.

In any event, such click activity may be tracked by the optional tracker, along with a network address for client device 200, a timestamp for when the click is detected, a URI associated with the click, text associated with the URI, or the like. Moreover, in one embodiment, the optional tracker may determine whether the click is associated with a URI, or not. In one embodiment, clicks unassociated with a URI may be tracked differently, or not at all.

Moreover, optional tracker may, in one embodiment, select to store at least some of the collected information within data storage 244. In another embodiment, or at a later time, the optional tracker may enable the collected information to be transmitted over a network to another computing device, such as GCT 106 of FIG. 1, or the like. In one embodiment, the transmitted information may be encrypted.

### Illustrative Server Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, GCT 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Mass memory also includes IP2geolocation data store (IDS) 352.

IDS 352 may represent a database, application, script, folder, or the like, that is configured to manage data that enables lookup of a physical geographical location using a network address. In one embodiment, the network address is an IP address. In one embodiment, the physical geographical location data may be in terms of latitude and longitude values. However, the invention is not so constrained, and other physical geographical location data may also be determined, including for example, a street address, or the like. In one embodiment, the geographical location data may also include other information, including a street address, a town name, city name, district name, county name, district name, state name, country name, continent name, or the like.

As illustrated, applications 350 also include optional click tracker 354 and geo-network activity reporter (GAP) 356. However, the invention is not limited to these applications residing within the same network device. For example, click tracker 354 may reside in one network device, such as content servers 107-109 of FIG. 1, while GAP 356 may reside within another network device, such as GCT 106 of FIG. 1. However, for ease of illustration, both are shown in this embodiment within the same network device.

As such, click tracker 354 is configured to monitor for click activity. In one embodiment, the monitoring is for click activity on a defined network site's web page. In one embodiment, when a click is detected on a body of the web page, a determination is made whether the click originates from a URI link within the web page. If it does, then click tracker 354 may collect information, including, but not limited to the URI link, a network address such as an IP address of the clicking client device, link text associated with the URI link, a timestamp associated with when the click is detected, or the like.

In one embodiment, click tracker 354 may also determine whether the click is to an outbound site, such as to a different domain than a domain in which current monitored web page is within. For example, in one embodiment, the click may be associated with an HTTP message that may include a referrer header field. The referrer header field may possibly including location information about from where the request may have linked to, such as another website, webpage, or the like. In one embodiment, the location information is a Universal Resource Identifier (URI), such as a Universal Resource Locator (URL), or the like. In any event, such information may also be collected. In one embodiment click tracker 354 may be configured to monitor defined click types, such as outbound clicks, for example.

In any event, click tracker 354 may, in one embodiment, employ the network address to search IDS 352 to determine a related geographical location. In another embodiment, click tracker 354 may store the collected information in a data store (not shown). In one embodiment, the data store may reside within mass memory, within hard disk drive 328, cd-rom/dvd-rom drive 326, or the like. In one embodiment, click tracker 354 may be configured to provide the collected information to another networking device. In one embodiment, click tracker 354 may provide the collected information to GAP 356 for analysis and reporting.

GAP 356 is configured to receive the collected information and to prepare for display network tracked activities based on geographical regions. GAP 356 may search IDS 352 using network address data within the collected information to determine a geographical location. GAP 356 may then aggregate collected data based on various geographical locations. For example, in one embodiment, GAP 356 may determine which network sites client devices that reside within a given geographical location may frequent. GAP 356 may further rank order the network sites based on a number of different client devices with the geographical location that visited that network site. In one embodiment, GAP 356 may rank order the network sites based on a number of visits of client devices within the geographical location. GAP 356 may aggregate such statistics on visits to network sites based on different geographical locations, including towns, cites, streets, neighborhoods, or any of the regions described above. However, GAP 356 is not constrained to determining network site statistics merely on a frequency of visits. GAP 356 may determine a variety of other statistics, as well. For example, GAP 356 may determine when during a given time period, such as mornings, afternoons, evenings, weekends, or the like, that network sites are visited based on geographic regions, or the like. GAP 356 may provide for display the statistics using a variety of display formats, including, but not limited to maps, tables, charts, lists, or the like. GAP 356 may also revise the network statistics based on additionally collected information over time.

FIGS. 5-6 illustrate embodiments of readership (visitor) statistics based on a geographic region. As illustrated in FIG. 5, display 500 includes a list 502 of most frequented network sites within a given geographic region 508. In this example, geographic region 508 is ‘worldwide.’ Also, in this example, list 502 includes a top 10 most frequented network sites. However, the invention is not so limited, and virtually any number of frequented network sites may be displayed, without departing from the scope of the invention. As shown, list 502 is a rank ordered list, wherein a first displayed network site (displayed as an URL) may be interpreted as the most frequented network site for geographic region 508. However, again, the invention is not so constrained. For example, the first displayed network site may also be based on a variety of other criteria. For example, in one embodiment, the rank ordering may be based on a number of clicks within the network site before a reader (visitor) clicked off of the site.

Also shown, a network site may be displayed with a URI 511 and/or with a text message 510 associated with the network site, such as a story topic, a network site title, header, or the like. It should also be noted that while display 500 illustrates list 502 as a list, the invention is not so constrained. For example, a table, histogram, bar chart, a geographic map, plot, or the like, may also be employed to display readership statistics based on a geographic region.

Display 500 also includes selectable sub-regions 504. As shown, various countries are displayed with selectable sub-regions 504. However, the invention is not so limited. For example, continents may be displayed, latitude/longitude regions, or the like, may also be employed. In one embodiment, the geographical regions may be further displayed based on a geopolitical region, geo-religious regions, geo-economic regions, or the like, without departing from the scope of the invention. Such other geo region information may be obtained from a variety of network available resources, including databases, other network sites, or the like.

In another embodiment, display 500 may include a selectable Really Simple Syndication (RSS) link 506 that may be configured to provide updates of display 500's contents to a computing device based on a variety of criteria, including, for example, when the rank order of lists 502 changes, or the like.

FIG. 6 illustrates another embodiment of an example display of readership statistics based on another geographic region. Thus, for example, in FIG. 5, a user may progressively increase a granularity for a region. For example, a user may select United States, then Washington state, and then Seattle, to obtain display 600 of FIG. 6.

As shown in FIG. 6, display 600 includes list 602 of most visited network sites by client devices identified to be located within the geographical region 608 of Seattle. Also shown is an RSS link 606 that may be used to obtain an alert when, for example, contents of display 600 changes. Although not illustrated within display 600, display 600 may also include selectable sub-regions, such as communities, neighborhoods, streets, or the like.

### Generalized Operation

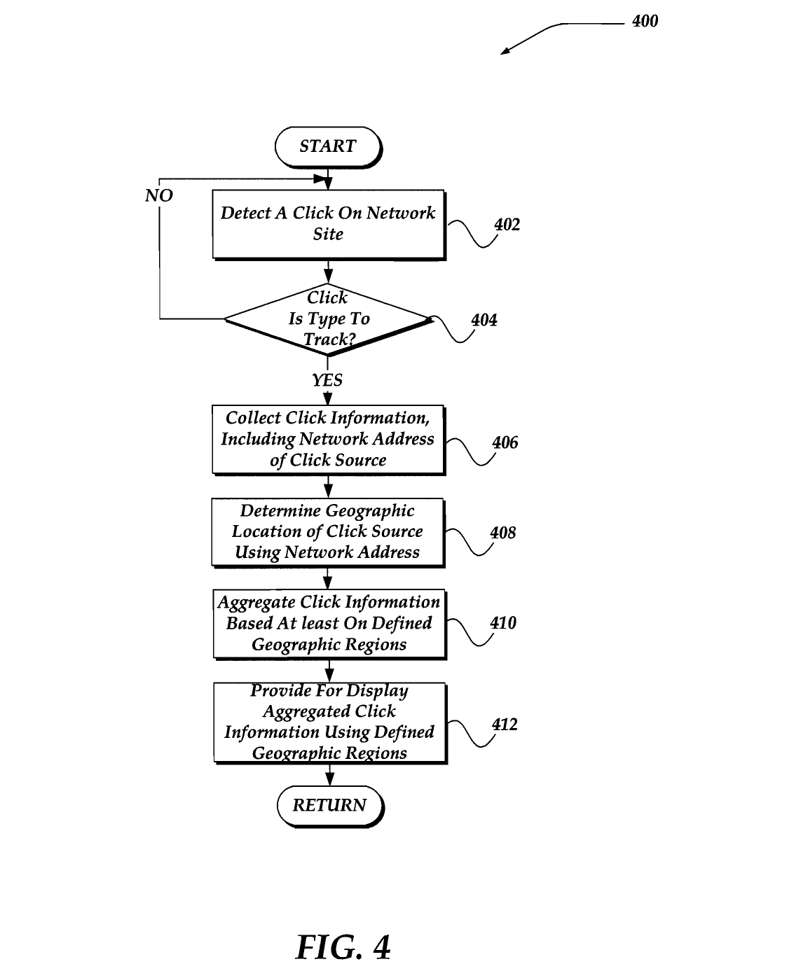

The operation of certain aspects of the invention will now be described with respect to FIG. 4. FIG. 4 illustrates a logical flow diagram generally showing one embodiment of a process for determining readership statistics of various websites, and enabling display of website readership based, in part, on a geographic region. Process 400 may be implemented within network device 300 of FIG. 3. However, process 400 may also be distributed across different computing devices. For example, in one embodiment, blocks 402, 404, and 406 may be implemented with content servers 107-109, and/or client devices 101-103 of FIG. 1, while the remaining blocks of process 400 may be implemented within GCT 106 of FIG. 1.

In any event, process 400 begins, after a start block, at block 402, where a click is detected on a network site be monitored. As described above, a visitor to the network site may land on a web page displayed by the network site from another network site, or even from no other network site. Moreover, in one embodiment the clicking on the network site may be monitored, as described above, by a JavaScript, and/or an application, applet, script, or the like on the network site. In another embodiment, the monitoring of clicks may be performed by a plug-in, script, applet, or the like, residing on the visitor's client device.

When a click is detected, processing moves to decision block 404 to determine whether the click is a type of click to be tracked. Clicks may represent a variety of actions. For example, a click may be a click to a link within the network site to another web page hosted by the network site. A click may also represent a click on a link that is an outbound link from the network site to another network site, a different domain, or the like. Clicks may also represent stray clicks by the visitor and may, for example, not be associated with any link. However, clicks may also represent a variety of other actions. In one embodiment, clicks associated with any link may be tracked. In another embodiment, clicks associated with outbound links may be tracked, while other clicks might be ignored, or the like. Such determination may be defined during an initial configuration of the click tracker, or may be defined at some other time. Thus, based on the defined click criteria, if the detected click is the type to be tracked, processing continues to block 406; otherwise, processing loops back to block 402 to monitor for another click.

At block 406, information associated with the click is collected. Such information may include a network address of the click source (the client device). For example, in one embodiment, the network address may be an IP address. However, the invention is not so constrained, and a phone number, MSN, or the like, may also be employed. In one embodiment, a physical geographical location may also be collected. Such information may be obtained, for example, during a communication with the click source. In addition, the collected information may include a URI associated with the click, text associated with the URI, or the like. In one embodiment, a type of client device associated with the click might also be obtained, and/or user account information may be obtained that may be employed to identify a user of the client device. In one embodiment, a timestamp may be generated for the collected information, based on when the click is detected.

In one embodiment, the collected information may be stored, and/or sent over a network to another computing device. In one embodiment, as additional information on clicks is collected it may be sent over the network, or stored, and sent over the network based on some event, such as a defined lapsed time, or the like.

Processing flows next to block 408, where the collected information may have been collected at a network device from a plurality of other network sites. For example, content servers 107-109 of FIG. 1, and/or one or more other network sites not shown, may provide collected information for selective clicks detected at that network site to GCT 106 of FIG. 1, or the like.

Then, at block 408, for each network address, a geographic location may be determined. In one embodiment, the geographic location may be determined using a network address to geographic location data store, database, lookup program, or the like. In one embodiment, perhaps based on the network address, the geographic location data, or the like, additional geo related information may also be obtained. For example, geo-political, geo-religious, geo-economic information, or the like, may also be obtained from a data store, database, lookup program, or the like.

Process 400 then flows to block 410, where the collected information from one or more of network sites may be aggregated, and a statistical analysis may be performed. For example, the collected information may be aggregated based on a defined geographical region, or other geo-related region. Then for a given geo region, a rank ordering of the visited network sites might be determined, such as described, for example, in conjunction with FIGS. 5-6. However, the invention is not constrained to examples illustrated in FIGS. 5-6, and virtually any statistical analysis of the collected click information may be performed based on a geo-related region.

In any event, processing continues to block 412, where the aggregated click information, including the determined statistical data may be provided for display using the defined geo-related regions. Process 400 then returns to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A system for managing network activities, comprising:
a content server that is configured to perform actions, including:
monitoring for a click activity on a displayed network page by a client device;
when the click activity is associated with a defined link, collecting information about the click activity including at least a network address of the client device; and
providing the collected information, including the network address over a network; and
a geo tracker server that is configured to perform actions, including:
receiving the collected information, including the network address;
determining a geo-related region associated with the network address;
determining statistical information from the collected information, including an aggregation of the collected information based on the determined geo-related region; and
enabling a display of the statistical information based on the determined geo-related region.

2. The system of claim 1, wherein the geo-related region comprises at least one of a geographic region, a geo-political region, a geo-religious region, or a geo-economic region.

3. The system of claim 1, wherein the geo tracker server that is configured to perform actions, further including:
determining a plurality of geo-related regions, wherein at least one geo-related region is a sub-set of another geo-related region; and
enabling a display of the statistical information based on the plurality of geo-related regions.

4. The system of claim 1, wherein the collected information includes at least one of a Uniform Resource Identifier (URI) link, or link text associated with the URI; and wherein a timestamp is determined for when the click activity is associated with a defined link is detected.

5. The system of claim 1, wherein determining statistical information further comprises:
determining a rank ordering of content servers based on the collected information, wherein the rank ordering represents a listing of content servers by frequency of visits by client devices within a defined geographically identified region.

6. The system of claim 1, further comprising:
a component residing on a client device that is configured to perform actions, including:
monitoring for a click activity on a displayed network page by the client device;
when the click activity is associated with a defined link, collecting information about the click activity including at least a network address of the client device; and
providing the collected information, including the network address over the network to the geo tracker server.

7. A processor readable medium that includes instructions, wherein the execution of the instructions provides for managing network analytics by enabling actions, including:
detecting a click activity on a displayed web page hosted by a server;
if the click activity is associated with a defined link, collecting information about the click activity including at least a network address associated with a network source of the click activity;
providing the collected information, including the network address over a network to another computing device, wherein the other computing device is configured to determine a geographical location associated with the network address, and to further enable display of statistical information based on the collected information using geographical regions based, in part, on the determined geographical location.

8. The processor readable medium of claim 7, wherein detected the click activity is performed by at least one of a plug-in, script, applet, or program residing within the network source of the click activity.

9. The processor readable medium of claim 7, wherein a defined link further comprises an outbound link from the server.

10. The processor readable medium of claim 7, wherein the display of statistical information further comprises for network addresses determined to be within a defined geographical region displaying statistical information on servers visited based on the collected information, wherein the statistical information includes a frequency of visits based on the collected information.

11. A network device to track network activity over a network, comprising:
a transceiver to send and receive data over the network; and
a processor that is operative to perform actions, including:
receiving from a plurality of servers click information associated with defined click activities at each server within the plurality of servers, wherein the click information includes a network address for each client device for a given click activity;
determining a geographical location for each client device based on the network address in the click information;
combining the click information from the plurality of servers based on the determined geographical locations of each client device; and
displaying the combined click information based on defined geographical regions associated with the client devices.

12. The network device of claim 11, wherein displaying the combined click information further comprises:
determining which servers within the plurality of servers are visited by client devices determined to be within a defined geographical region based on the click information; and
displaying server information for the visited servers for the defined geographical region.

13. The network device of claim 11, wherein displaying the combined click information further comprises displaying the information in a table, a list, based on a geographical map, or a chart.

14. A client device that is operative to enable tracking of network activity, comprising:
a memory component for storing data; and
a processing component for executing data that enables actions, including:
detecting a click activity on a displayed web page hosted by a server;
if the click activity is associated with a defined link, collecting information about the click activity including at least a network address of the client device; and
providing the collected information, including the network address to another computing device, wherein the other computing device is configured to determine a geographical location associated with the network address, and to further enable display of the collected information using geographical regions based, in part, on the determined geographical location of the client device.

15. The client device of claim 14, wherein detecting the click activity further comprises employing a browser tool bar plug-in, and wherein the displayed web page is associated with a blog.

16. The client device of claim 14, where enabling a display of the collected information further comprises:
aggregating collected information from a plurality of client devices within a same geographical region, wherein the aggregated collected information is an ordering of servers visited by the plurality of client devices within the same geographical region.

17. A method of managing network activity over a network, comprising:
monitoring for a click activity at a server by a client device visiting the server;
when the click activity is associated with a defined link, collecting click information about the click activity including at least a network address of the client device;
receiving a plurality of click information from a plurality of servers over the network;
determining a geo-related region associated with each network address in the plurality of click information from the plurality of servers;
determining statistical information from the plurality of click information; and
enabling a display of the statistical information based on the determined geo-related regions.

18. The method of claim 17, wherein enabling a display of the statistical information further comprises:
enabling a display of information about servers visited by client devices determined to be within a determined geo-related region.

19. The method of claim 17, wherein monitoring for a click activity at a server further comprises employing at least one of a script, an applet, or a program.

20. The method of claim 17, wherein a defined link further comprises a link displayed at a server, wherein the link is configured to enable the client device to display content at a different server.

21. A modulated data signal configured to include program instructions for performing the method of claim 17.
